(19) United States
(12) Patent Application Publication
(10) Pub. No.: US 2006/0124173 A1
(43) Pub. Date: Jun. 15, 2006

(54) Mass flow controller

(76) Inventor: Hyeon-Su An, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/292,766

(22) Filed: Dec. 2, 2005

(30) Foreign Application Priority Data
Dec. 14, 2004 (KR) 2004-105903

(51) Int. Cl. G05D 7/06

(52) U.S. Cl. 137/487.5

(57) ABSTRACT

A mass flow controller includes a leak preventor mechanism having grooves disposed on a valve seat within the gas supply line and/or a particle trap disposed between a control valve and the discharge part configured to prevent particles from being introduced into the control valve in case of backpressure. The mass flow controller further includes a controller body having a flow path for fluid flow, an inlet part for introducing the fluid into the flow path, and a discharge part for discharging the fluid from the flow path. A mass flow sensor is installed adjacent to the inlet part of the controller body and connects to the flow path for measuring a mass flow of the fluid passing through the flow path. The control valve is installed adjacent to the discharge part of the controller body and is connected to the flow path for adjusting the mass flow of the fluid passing through the flow path by operation of a valve controller that compares the mass flow measured by the mass flow sensor and a reference flow in order to control the control valve such that the mass flow of the fluid is equal to the reference flow.

### BACKGROUND OF THE INVENTION

1. Cross-References to Related Applications

This U.S. nonprovisional patent application claims priority under 35 U.S.C. § 119 of Korean Patent Application 10-2004-0105903 filed on Dec. 14, 2004, the entire contents of which are hereby incorporated by reference.

2. Field of the Invention

The present invention relates to a mass flow controller for adjusting mass flow of fluid.

3. Description of the Prior Art

Generally, a semiconductor device is manufactured by repeatedly performing a plurality of unit processes such as photolithography, etching, deposition, ion implantation, metallization, and so on.

Most of the unit processes use various kinds of gases by interconnecting a reaction chamber for performing the processes and a gas supply source for supplying gas into the reaction chamber through a gas supply pipe.

To precisely perform the processes, it is necessary to precisely control flow of the gases used in the processes. In particular, it is even more important to precisely control the flow of the gases as the integration density of semiconductor devices increase since minor variations of process conditions may adversely impact the manufacture throughput of such semiconductor devices.

Accordingly, it is common for most semiconductor manufacturing equipment to include a mass flow controller (MFC) for precisely controlling the flow of the gases used in manufacturing the semiconductor devices.

Specifically, the MFC is installed on the gas supply pipe connecting the gas supply source and the reaction chamber in order to control the flow of the gas required in the processes. Therefore, when a certain amount of standard flow of the gas is required to perform the processes, the MFC precisely measures and adjusts the flow of the gas introduced into the reaction chamber. Then, when a predetermined amount of gas is supplied, the MFC closes the supply path through which the gas is supplied to block the gas supply into the reaction chamber. As a result, the gas amount is precisely supplied into the reaction chamber, thus smoothly performing the processes performed to construct the semiconductor device.

However, when blocked, the gas supplied into the reaction chamber may flow temporarily backward through the gas supply pipe and the MFC (hereinafter, referred to as “backpressure”). Therefore, particles generated in the reaction chamber may be sucked back into the MFC due to the action of this backpressure. This introduction of particles into the MFC can cause leakage of a valve during a subsequent process thereby making it difficult to control a flow of the gas, thereby lowering the yield of the semiconductor device.

Accordingly, it is desired to introduce designs for mass flow controllers that address this backflow problem that exists with prior art devices.

### SUMMARY OF THE INVENTION

In one embodiment, the invention is directed to a mass flow controller including: a controller body having a flow path for fluid flow, an inlet part for introducing the fluid into the flow path, and a discharge part for discharging the fluid from the flow path; a mass flow sensor, installed adjacent to the inlet part of the controller body and connected to the flow path, for measuring a mass flow of the fluid passing through the flow path; a control valve, installed adjacent to the discharge part of the controller body and connected to the flow path, for adjusting the mass flow of the fluid passing through the flow path; a valve controller for comparing the mass flow measured by the mass flow sensor and a reference flow to control the control valve such that the mass flow of the fluid is equal to the reference flow; and a leak prevention means for preventing the control valve from leaking due to particles introduced into the flow path.

The control valve may include a valve seat installed in the flow path and having a fluid through-hole for passing through the fluid, and a valve body selectively contacting the valve seat to open/close the fluid through-hole. The control valve may be a solenoid valve or an air valve.

In addition, the leak prevention means may include at least one leak prevention groove provided on a contact surface of the valve seat in contact with the valve body to trap the particles introduced into the flow path. In this case, the leak prevention groove may be formed in a loop shape to surround the fluid through-hole.

Further, the leak prevention means may be formed of a leak prevention uneven surface disposed at the contact surface of the valve seat in contact with the valve body.

Meanwhile, a particle trapping means for preventing particles from being introduced into the control valve may be installed at the flow path between the control valve and the discharge part.

In a preferred embodiment, the particle trapping means may be formed of a particle trap disposed on an inner wall of the flow path between the control valve and the discharge part to capture the particles introduced into the flow path. In this case, the particle trap may be formed adjacent to the control valve. In addition, the particle trap may be composed of a plurality of trapping grooves disposed on the inner wall of the flow path. Further, the particle trap may be a particle trapping uneven surface disposed along the inner wall of the flow path. Furthermore, the particle trap may be a particle trapping projection sloped downward on the inner wall of the flow path.

In another embodiment, the invention is directed to a mass flow controller including: a controller body having a flow path for fluid flow, an inlet part for introducing the fluid into the flow path, and a discharge part for discharging the fluid from the flow path; a mass flow sensor, installed adjacent to the inlet part of the controller body and connected to the flow path, for measuring a mass flow of the fluid passing through the flow path; a control valve, installed adjacent to the discharge part of the controller body and connected to the flow path, for adjusting the mass flow of the fluid passing through the flow path; a valve controller for comparing the mass flow measured by the mass flow sensor and a reference flow to control the control valve such that the mass flow of the fluid is equal to the reference flow; and a particle trapping means disposed at the flow path between the control valve and the discharge part to prevent particles from being introduced into the control valve.

In still another embodiment, the invention is directed to a mass flow controller including: a controller body installed at a gas supply pipe between a gas supply source and a reaction chamber and having a flow path for gas flow, an inlet part for introducing the gas into the flow path, and a discharge part for discharging the gas from the flow path; a mass flow sensor, installed adjacent to the inlet part of the controller body and connected to the flow path, for measuring a mass flow of the gas passing through the flow path; a control valve, installed adjacent to the discharge part of the controller body and connected to the flow path, for adjusting the mass flow of the gas passing through the flow path; a valve controller for comparing a signal generated from the mass flow sensor and a reference signal corresponding to a reference flow to control the control valve such that the mass flow of the gas is equal to the reference flow; a leak prevention means for preventing the control valve from leaking due to particles introduced into the flow path; and a particle trapping means disposed at the flow path between the control valve and the discharge part to prevent particles from being introduced into the control valve.

The leak prevention means may be formed of at least one leak prevention groove disposed at a contact surface of a valve seat in contact with the valve body, and formed in a loop shape to surround a fluid through-hole.

In addition, the particle trapping means may be formed of at least one particle trap disposed on an inner wall of the flow path between the control valve and the discharge part.

### BRIEF DESCRIPTION OF THE DRAWINGS

The foregoing and other objects, features and advantages of the invention will be apparent from the more particular description of a preferred embodiment of the invention, as illustrated in the accompanying drawings. The drawings are not necessarily to scale, emphasis instead being placed upon illustrating the principles of the invention.

FIG. 1 is a conceptual view of semiconductor manufacturing equipment employing a mass flow controller in accordance with the present invention;

FIG. 2 a cross-sectional view illustrating an embodiment of a mass flow controller in accordance with the present invention;

FIG. 3 is a cross-sectional view illustrating opening/closing operations of a flow path of the mass flow controller of FIG. 2;

FIG. 4 is a cross-sectional view illustrating an embodiment of A-portion of FIG. 2;

FIG. 5 is a cross-sectional view illustrating another embodiment of A-portion of FIG. 2;

FIG. 6 is a cross-sectional view illustrating an embodiment of B-portion of FIG. 2;

FIG. 7 is a cross-sectional view illustrating another embodiment of B-portion of FIG. 2; and

FIG. 8 is a cross-sectional view illustrating still another embodiment of B-portion of FIG. 2.

### DETAILED DESCRPTION OF THE INVENTION

Hereinafter, the detailed description of a preferred embodiment in accordance with the present invention will be apparent in connection with the accompanying drawings.

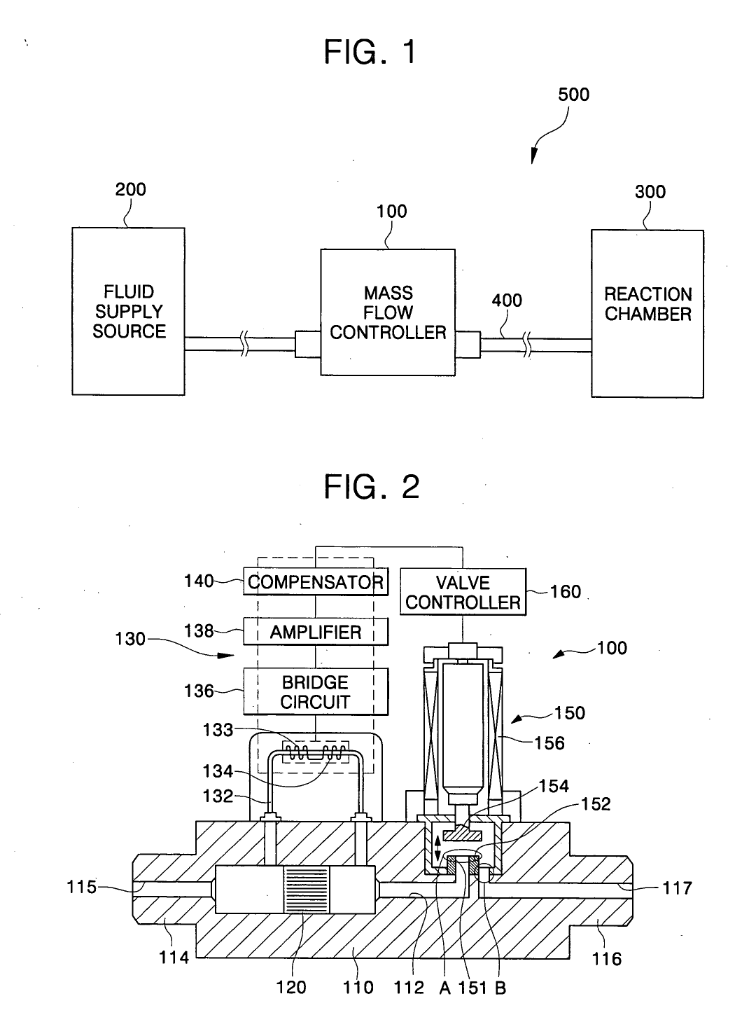

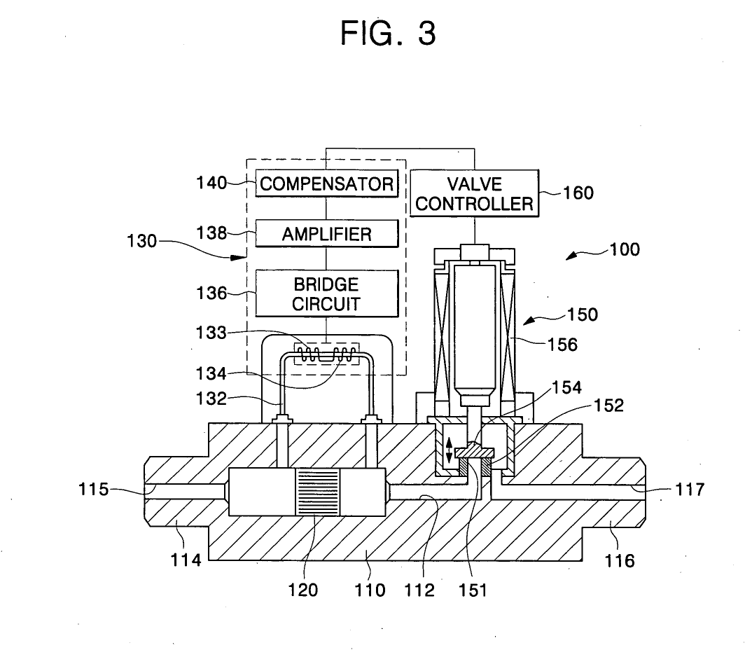

First, referring to FIG. 1, the mass flow controller 100 in accordance with the present invention is installed at semiconductor manufacturing equipment 500 to control a flow of fluid such as gas or liquid used in the semiconductor manufacturing equipment 500.

Specifically, process fluid is supplied from a fluid supply source 200 to a reaction chamber 300 of the semiconductor manufacturing equipment 500 through a fluid supply pipe 400, and the mass flow controller 100 is installed on the fluid supply pipe 400 to control a flow of the fluid supplied into the reaction chamber 300 such that the flow is equal to a reference flow.

Meanwhile, FIG. 2 illustrates an embodiment of a mass flow controller in accordance with the present invention.

Referring to FIG. 2, the mass flow controller 100 in accordance with the present invention includes a controller body 110, a mass flow sensor 130, a control valve 150, a valve controller 160, a leak prevention means, and a particle trapping means.

More specifically, the controller body 110 is installed on the fluid supply pipe 400, and has a flow path 112 formed to pass through the controller body 110 for the fluid flow, an inlet part 114 for introducing the fluid supplied from the fluid supply pipe 400 into the flow path 112, and a discharge part 116 for discharging the fluid passed through the flow path 112 to the fluid supply pipe 400. Therefore, the fluid introduced into the inlet part 114 of the controller body 110 flows along the flow path 112 and then is discharged to the exterior through the discharge part 116 of the controller body 110.

The mass flow sensor 130 is installed adjacent to the inlet part 114 of the controller body 110 and connected to the flow path 112 and measures the mass flow of the fluid passing the flow path 112.

Specifically, the mass flow sensor 130 measures the mass flow of the fluid passing through a bypass 120 in the controller body 110, and includes a sample pipe 132 for sampling the fluid, first and second heating resistors 133 and 134 wound on the sample pipe 132, a bridge circuit 136 connected between the first and second heating resistors 133 and 134, an amplifier 138 connected to the bridge circuit 136, and a compensator 140 connected to the amplifier 138.

The bypass 120 is disposed in the flow path 112 adjacent to the inlet part 114 of the controller body 110 to make the fluid passing through the flow path show laminar flow.

The sample pipe 132 is connected to a first part of the flow path 112 between the inlet part 114 and the bypass 120 and a second part of the flow path 112 between the bypass 120 and the control valve 150 such that the fluid passing through the bypass 120 can be sampled. Therefore, a portion of the fluid passes through the bypass 120 via the sample pipe 132.

The first and second heating resistors 133 and 134 are wound on upstream and downstream sides of the sample pipe 132, respectively, and heated by the fluid passing through the sample pipe 132, thereby having a resistance value in proportion to the mass flow of the fluid. In this process, the first and second heating resistors 133 and 134 are made of Pt, or similar metals.

The bridge circuit 136 functions to generate an electrical signal corresponding to a temperature difference between the upstream and downstream sides of the sample pipe 132, e.g. when the first and second heating resistors 133 and 134 are heated by the fluid flowing through the sample pipe 132. Specifically, when the first and second heating resistors 133 and 134 are heated, the temperature difference in proportion to the mass flow of the fluid is generated between the upstream and downstream sides of the sample pipe 132 so that the first and second heating resistors 133 and 134 wound on the upstream and downstream sides also have different resistance values according to the temperature difference. Therefore, the bridge circuit 136 generates a predetermined electrical signal according to variation of the resistance value.

The amplifier 138 functions to amplify an electrical signal detected by the bridge circuit 136. The compensator 140 functions to compensate the signal amplified by the amplifier 138 such that the signal is corresponded with the mass flow of the fluid passing through the bypass 120.

Meanwhile, the control valve 150 includes a valve seat 152, a valve body 154, and a drive unit 156.

Specifically, the valve seat 152 is disposed in the flow path 112 between the downstream side of the sample pipe 132 and the discharge part 116 of the controller body 110, and has a fluid through-hole 151 having a predetermined size sufficient to pass through the fluid flowing through the flow path 112.

The valve body 154 functions to selectively contact the valve seat 152 to open/close the fluid through-hole 151 of the valve seat 152. Therefore, the fluid introduced into the control valve 150 through the flow path 112 flows to the discharge part 116 through the fluid through-hole 151 of the control valve 150, only when the valve body 154 opens the fluid through-hole 151.

The drive unit 156 functions to move the valve body 154 to open/close the fluid through-hole 151 of the valve seat 152. Therefore, the drive unit 156 may be formed in various shapes. For example, when the control valve 150 is formed of a solenoid valve, the drive unit 156 may be a solenoid. In addition, when the control valve 150 is formed of an air valve, the drive unit 156 may be an air supply unit for supplying air to both sides of the valve body 156.

The valve controller 160 functions to receive the compensated signal from the compensator 140 and appropriately control the operation of the control valve 150 responsive to the measurements received. Specifically, the signal compensated by the compensator 140 is transmitted to the valve controller 160, which compares a reference signal corresponding to a set reference flow and the signal compensated by the compensator 140 to control the control valve 150 such that the mass flow measured by the mass flow sensor 130 is equal to the set reference flow. Therefore, the fluid supplied through the mass flow controller becomes equal to the set reference flow.

The leak prevention means serves to prevent the control valve 150 from leaking due to particles introduced into the flow path 112 of the controller body 110. Therefore, the leak prevention means may be disposed in the control valve 150.

Specifically, the leak prevention means may be formed of at least one leak prevention groove 120 disposed at a contact surface of the valve seat 152 in contact with the valve body 154. In this case, the particles introduced into the flow path 112 can be trapped by the leak prevention groove 120 to prevent the control valve 150 from leaking due to the particles.

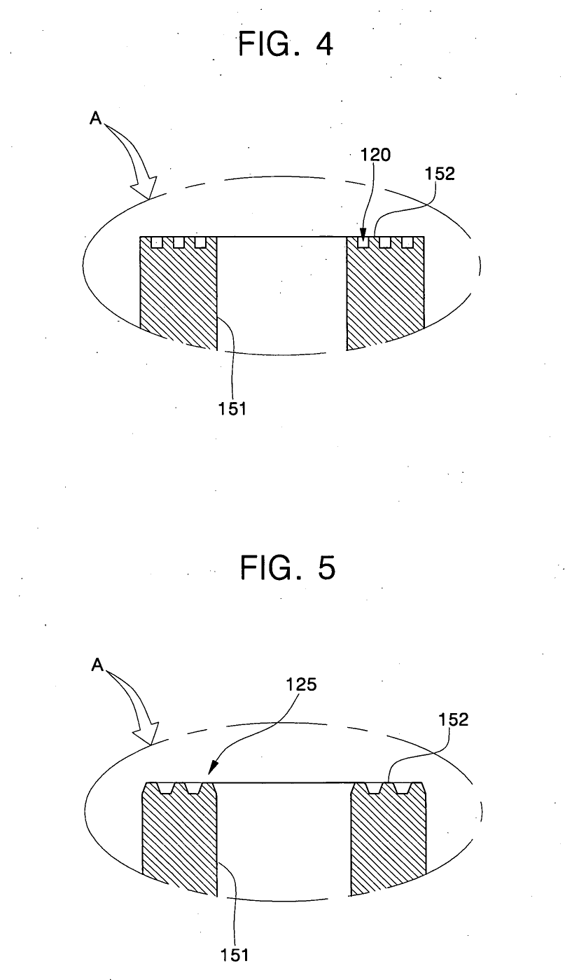

In addition, the at least one leak prevention groove 120 disposed at the contact surface of the valve seat 152 may have a loop or annular shape for surrounding the fluid through-hole 151. In this way, the leak prevention groove acts as a moat circumferentially surrounding the fluid through-hole 151 thereby dividing the valve seat into an annular portion proximal the fluid through-hole and a second annular portion distal the fluid through-hole, with the leak prevention groove interposed between the distal and proximal portions of the valve seat. Multiple grooves would be like multiple nested moats where a break in one (caused by particle leak and consequent deposit on the valve seat 152 surface) is stopped by the integrity of the other valve sections. Therefore, the contact surface of the valve seat 152 in contact with the valve body 154 is divided into large numbers due to the multiple loop-shaped leak prevention grooves 120 (FIG. 4). As a result, even when the leak is generated from any one of the plurality of contact surfaces of the valve seat 152 in contact with the valve body 154 due to the particles introduced into the flow path 112, at least one surface of the valve seat 152 is in contact with the valve body 154 to prevent the leak generated from the one contact surface from propagating to all valve sections.

In addition, the leak prevention means may be formed of a leak prevention uneven surface 125 (see FIG. 5) disposed at the contact surface of the valve seat 152 in contact with the valve body 154. In this case, the contact surface of the valve seat 152 in contact with the valve body 154 is divided into a plurality of parts due to the uneven surface. Therefore, even when the leak is generated from any one of the plurality of contact surfaces of the valve seat 152 in contact with the valve body 154 due to the particles introduced into the flow path 112, at least one surface of the valve seat 152 is in contact with the valve body 154 to prevent the leak generated from the one contact surface from propagating to all valve sections.

Meanwhile, the particle trapping means is disposed at the flow path 112 between the control valve 150 and the discharge part 116 to prevent the particles from being introduced into the control valve 150 when the backpressure is generated.

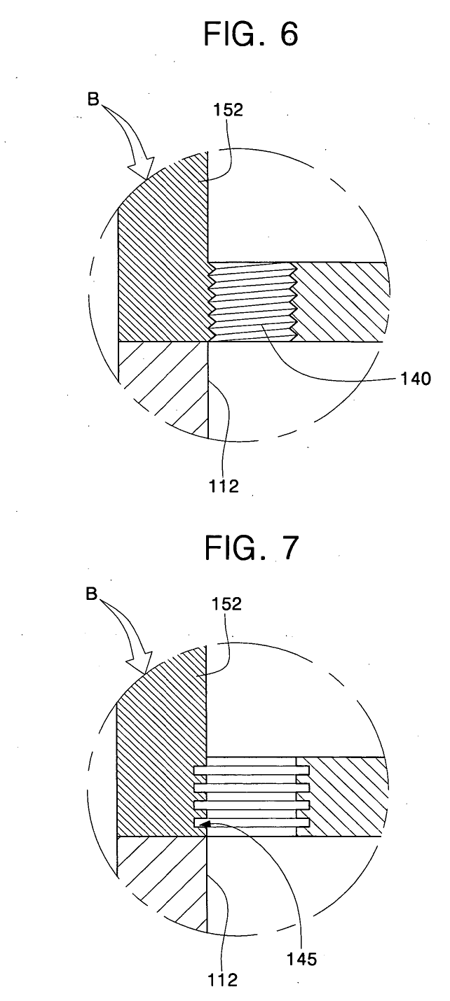

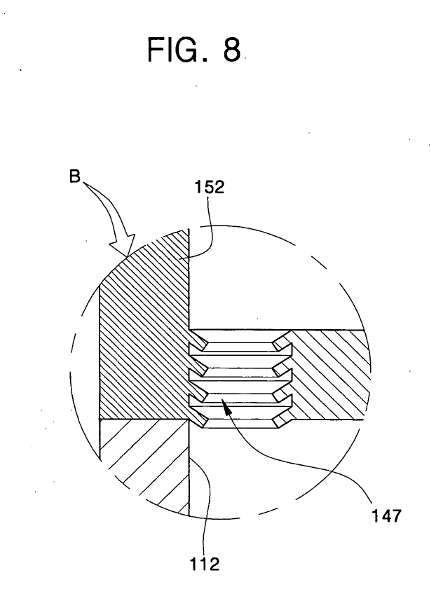

Specifically, the particle trapping means may be formed of a particle trap disposed on an inner wall of the flow path 112 between the control valve 150 and the discharge part 116 to capture the particles introduced into the flow path 112. In this case, the particle trap may be formed to have any shape capable of minimally affecting the fluid flowing through the flow path 112 and trapping the particles introduced into the flow path 112. For example, the particle trap may be a particle trapping uneven surface 140 formed along the inner wall of the flow path 112 to have a female thread shape as shown in FIG. 6, a plurality of particle trapping grooves 145 disposed at the inner wall of the flow path 112 as shown in FIG. 7, and a plurality of particle trapping projections 147 sloped downward from the inner wall of the flow path 112 as shown in FIG. 8. Therefore, the particles introduced through the flow path 112 are trapped by the particle trapping means to minimize the leakage due to the particles. In this process, preferably, the particle trap is disposed adjacent to the control valve 150.

A reference numeral 115 designates a fluid inlet port for introducing the fluid, and a reference numeral 117 designates a fluid discharge port for discharging the fluid.

Hereinafter, operation and effect of the mass flow controller in accordance with the present invention will be described in conjunction with the accompanying drawings.

First, as shown in FIG. 1, the mass flow controller 100 is installed on the fluid supply pipe 400 for connecting the fluid supply source 200 and the reaction chamber 300 to control the mass flow of the fluid supplied into the reaction chamber 300.

Therefore, when the fluid is supplied into the reaction chamber 300 after a certain reference flow of process fluid is set, the mass flow controller 100 precisely measures and adjusts the flow of the fluid introduced into the reaction chamber 300 through the mass flow controller 100 such that the fluid can be supplied into the reaction chamber 300 at a precise flow.

Specifically, when the fluid supplied from the fluid supply source 200 to be introduced into the inlet part 114 of the mass flow controller 100 flows along the bypass 120 and the sample pipe 132 through the flow path 112, the mass flow sensor 130 measures the mass flow of the fluid passing through the flow path 112 using the bridge circuit 136, the amplifier 138 and the compensator 140.

Then, when the mass flow of the fluid is measured, the compensator 140 generates a signal corresponding to the mass flow and transmits the signal to the valve controller 160. Therefore, the valve controller 160 compares a reference signal corresponding to the set reference flow and the compensated signal to control the operation of the control valve 150 such that the mass flow measured by the mass flow sensor 130 is equal to the set reference flow. As a result, only the flow of the fluid equal to the set reference flow is introduced into the reaction chamber.

Then, when the flow of the fluid equal to the set reference flow is entirely introduced into the reaction chamber, the valve controller 160 transmits a cut off signal to the control valve 150. Therefore, the drive unit 156 of the control valve 150 drives the valve body 154 to block the fluid through-hole 151 disposed at the valve seat 152, thereby blocking the introduction of the fluid into the reaction chamber 300.

Meanwhile, when the fluid supplied into the reaction chamber 300 is blocked, the back pressure is generated in the fluid supply pipe 400 and the mass flow controller 100 so that the fluid supplied into the reaction chamber 300 temporarily flows backward. Therefore, the particles generated in the reaction chamber 300 may be introduced into the interior of the flow path 112 of the controller body 110 to cause the leakage of the control valve 150 due to the backpressure during the subsequent process.

However, the mass flow controller 100 in accordance with the present invention is capable of preventing the valve from leaking even when the particles are introduced into the controller body due to the backpressure, since the controller 100 includes the leak prevention means for preventing the valve from leaking.

In addition, the mass flow controller 100 in accordance with the present invention is also capable of trapping most particles introduced into the controller body using the particle trapping means for preventing the particles in the reaction chamber 300 from being introduced into the control valve 150 due to the backpressure. Therefore, in accordance with the present invention, the leakage of the valve can be completely solved.

As can be seen from the foregoing, the mass flow controller in accordance with the present invention includes the leak prevention means for preventing the valve from leaking. Therefore, there is little probability of leakage of the valve even when the particles are introduced into the controller body due to the backpressure.

In addition, the mass flow controller in accordance with the present invention includes the particle trapping means for preventing the particles in the reaction chamber from being introduced into the control valve due to the backpressure to enable the particle trapping means to trap the particles introduced into the controller body.

Therefore, it is possible to solve the problems such as the leakage of the valve, difficulties in control of the flow of the gas, decrease of the yield of the semiconductor device, and so on.

While this invention has been described in connection with what is presently considered to be the most practical and preferred embodiment, it is to be understood that the invention is not limited to the disclosed embodiment, but on the contrary, it is intended to cover various modifications within the spirit and the scope of the Invention, which is set forth in the appended claims.

What is claimed is:

1. A mass flow controller comprising:
a controller body having a flow path for fluid flow, an inlet part for introducing the fluid into the flow path, and a discharge part for discharging the fluid from the flow path;
a mass flow sensor, installed adjacent to the inlet part of the controller body and connected to the flow path, for measuring a mass flow of the fluid passing through the flow path;
a control valve, installed adjacent to the discharge part of the controller body and connected to the flow path, for adjusting the mass flow of the fluid passing through the flow path;
a valve controller for comparing the mass flow measured by the mass flow sensor and a reference flow to control the control valve such that the mass flow of the fluid is equal to the reference flow; and
a leak prevention means for preventing the control valve from leaking due to particles introduced into the flow path.

2. The mass flow controller according to claim 1, wherein the control valve comprises:
a valve seat installed in the flow path and having a fluid through-hole through which the fluid passes; and
a valve body selectively contacting the valve seat to open/close the fluid through-hole.

3. The mass flow controller according to claim 2, wherein the control valve is one of a solenoid valve and an air valve.

4. The mass flow controller according to claim 2, wherein the leak prevention means comprises at least one leak prevention groove provided on a contact surface of the valve seat in contact with the valve body to trap the particles introduced into the flow path.

5. The mass flow controller according to claim 4, wherein the leak prevention groove is formed in a loop shape to surround the fluid through-hole thereby dividing the valve seat into an annular portion proximal the fluid through-hole and a second annular portion distal the fluid through-hole, with the leak prevention groove interposed between the distal and proximal portions of the valve seat.

6. The mass flow controller according to claim 2, wherein the leak prevention means includes a leak prevention uneven surface disposed at the contact surface of the valve seat in contact with the valve body.

7. The mass flow controller according to claim 1, further including a particle trapping means installed at the flow path between the control valve and the discharge part for preventing the particles from being introduced into the control valve.

8. The mass flow controller according to claim 7, wherein the particle trapping means includes a particle trap disposed at an inner wall of the flow path between the control valve and the discharge part to capture the particles introduced into the flow path.

9. The mass flow controller according to claim 8, wherein the particle trap is formed adjacent to the control valve.

10. The mass flow controller according to claim 8, wherein the particle trap is composed of a plurality of trapping grooves disposed along the inner wall of the flow path.

11. The mass flow controller according to claim 8, wherein the particle trap is a particle trapping uneven surface disposed on the inner wall of the flow path.

12. The mass flow controller according to claim 11, wherein the uneven surface has a female thread shape.

13. The mass flow controller according to claim 8, wherein the particle trap is a particle trapping projection sloped downward on the inner wall of the flow path.

14. A mass flow controller comprising:
a controller body having a flow path for fluid flow, an inlet part for introducing the fluid into the flow path, and a discharge part for discharging the fluid from the flow path;
a mass flow sensor, installed adjacent to the inlet part of the controller body and connected to the flow path, for measuring a mass flow of the fluid passing through the flow path;
a control valve, installed adjacent to the discharge part of the controller body and connected to the flow path, for adjusting the mass flow of the fluid passing through the flow path;
a valve controller for comparing the mass flow measured by the mass flow sensor and a reference flow to control the control valve such that the mass flow of the fluid is equal to the reference flow; and
a particle trapping means disposed at the flow path between the control valve and the discharge part to prevent particles from being introduced into the control valve.

15. The mass flow controller according to claim 14, wherein the particle trapping means comprises a particle trap disposed on an inner wall of the flow path between the control valve and the discharge part to capture the particles introduced into the flow path.

16. The mass flow controller according to claim 15, wherein the particle trap is formed adjacent to the control valve.

17. The mass flow controller according to claim 15, wherein the particle trap is composed of a plurality of trapping grooves disposed on the inner wall of the flow path.

18. The mass flow controller according to claim 15, wherein the particle trap is a particle trapping uneven surface disposed along the inner wall of the flow path.

19. The mass flow controller according to claim 18, wherein the uneven surface has a female thread shape.

20. The mass flow controller according to claim 15, wherein the particle trap is a particle trapping projection sloped downward on the inner wall of the flow path.

21. A mass flow controller comprising:
a controller body having a flow path for fluid flow, an inlet part for introducing the fluid into the flow path, and a discharge part for discharging the fluid from the flow path;
a mass flow sensor, installed adjacent to the inlet part of the controller body and connected to the flow path, for measuring a mass flow of the fluid passing through the flow path;
a control valve, installed adjacent to the discharge part of the controller body and connected to the flow path, for adjusting the mass flow of the fluid passing through the flow path;
a valve controller for comparing the mass flow measured by the mass flow sensor and a reference flow to control the control valve such that the mass flow of the fluid is equal to the reference flow;
a leak prevention means for preventing the control valve from leaking due to particles introduced into the flow path; and
a particle trapping means disposed at the flow path between the control valve and the discharge part to prevent particles from being introduced into the control valve.

22. The mass flow controller according to claim 21,
wherein the control valve comprises a valve seat installed in the flow path and having a fluid through-hole through which the fluid flow, and a valve body selectively contacting the valve seat to open/close the fluid through-hole, and
wherein the leak prevention means comprises at least one leak prevention groove disposed at a contact surface of the valve seat in contact with the valve body and formed in a loop shape to surround the fluid through-hole.

23. The mass flow controller according to claim 21, wherein the particle trapping means comprises at least one particle trap disposed on an inner wall of the flow path between the control valve and the discharge part.
